(19) United States
(12) Patent Application Publication
(10) Pub. No.: US 2005/0060203 A1
(43) Pub. Date: Mar. 17, 2005

(54) RESPA compliant title insurance commitment system

(76) Inventors: John T. LaJoie, Tallahassee, FL (US); Susan L. Rossburg, Odessa, FL (US)

Correspondence Address: AKERMAN SENTERFITT, P.O. BOX 3188, WEST PALM BEACH, FL, 33402-3188, US

(21) Appl. No.: 10/650,180

(22) Filed: Aug. 28, 2003

(51) Int. Cl. G06F 17/60

(52) U.S. Cl. 705/4

(57) ABSTRACT

An automated system for producing a title insurance commitment can include a database of title evidence images which can be viewed through an image viewer. As required by RESPA, a title insurance examiner can produce a title insurance commitment based upon a review of the title insurance evidence presented through the image viewer. A first set of multi-locality textual clauses can be provided, which clauses can specify minimal requisite language for a title commitment. A second set of multi-locality textual clauses further can be provided, which clauses can specify minimal exclusionary language for a title commitment. The system yet further can include a filter for reducing the first and second sets to locality-specific textual clauses of minimal requisite and exclusionary language. A user interface can be configured to present the locality specific textual clauses in selectable form. Consequently, a title commitment processor can be programmed to generate a title commitment based upon selected ones of the locality specific textual clauses.

### BACKGROUND OF THE INVENTION

1. Statement of the Technical Field

The present invention relates to the field of title insurance and more particularly to title insurance commitment processing.

2. Description of the Related Art

Although title insurance forms a critical portion of most commercial and residential real estate transactions, few sellers, buyers, and lenders truly understand the title insurance product. In the prototypical real estate transaction, the buyer generally seeks evidence that the title that the buyer proposes to acquire is a marketable title. Similarly, lenders required evidence of their priority in a mortgage. In both cases, the evidence of marketable title and priority historically has taken many forms, such as a title certificate from a government office, or an abstract of title and attorney's title opinion. Today, in almost all real estate transactions the title insurance vehicle remains the most commonly used vehicle for establishing evidence of title, because title insurance provides a faster, cheaper, and broader measure of protection than other evidentiary vehicles.

The conventional title insurance policy insures the status of the state of title to a specific parcel of real property. In this regard, the title insurance policy is a statement by a title insurance company that, in exchange for a premium, the title insurance company will assume the risk that title to a parcel of real estate is as it is stated to be in the policy. Thus, the title insurance policy acts to indemnify the insured party against losses suffered if title to the property is not as the policy states it to be. A policy of title insurance may be purchased from a title insurance company, which typically must have been licensed by the state body having jurisdiction over insurance companies, to underwrite this form of insurance. The purchase price for the policy typically is referred to as the “premium.”

The process of acquiring title insurance begins with the “title insurance commitment”. At the outset, the history of a subject property can be researched across a number of sources, for example in the records of the register of deeds; the county treasurer, the clerk of courts, etc. A title examiner licensed by the state of pertinent jurisdiction can analyze the results of the title search and can compile the results of the analysis into a title insurance commitment. The title insurance commitment itself can be a document in which a title insurance company promises to issue its title insurance policy in the form and as of the date set forth in the commitment upon payment of its premium. This promise is given in response to an order from a customer and remains valid for a specified term, after which the promise will “expire”.

Mechanically speaking, a title insurance commitment contains a description of the property to be insured, the name of the proposed insured, the name of the proposed insured, and the coverage limits of the policy to be issued. The title insurance commitment further can identify the current owner of the property and the specific policy form that the company will use to insure title. A commitment also can contain a list of requirements that are conditions to the issuance of a title policy and a statement of any standard and non-standard exceptions to title that exist and for which no insurance coverage will be provided.

Notably, a title insurance commitment is not considered a “policy of insurance.” In this regard, a title company has no obligation under a title insurance commitment except to issue a policy when the premium is paid on a timely basis. Although a few reported court decisions have created a concept referred to as “abstractor's liability” when justifiable reliance exists, as a general rule, if a title insurance commitment ultimately includes incorrect conclusions, for example, where the commitment fails to reflect a prior mortgage or other defect in title, the holder of the commitment will have no recourse against the title company unless a policy of title insurance has been issued.

It will be recognized by the title insurance professional that the process of producing a title insurance commitment can be manual in nature and quite tedious. Yet, much of the title insurance commitment process is repetitive in nature across multiple requests for title insurance. Hence, the title insurance commitment process can lend itself well to computerized automation. Recognizing the mechanical nature of title insurance commitment processing, several technologies have been marketed for some time which act as “document assemblers” in the title insurance commitment process. Mostly configured as word processing templates, these document assemblers merely provide the boiler plate necessary for the title insurance examiner to issue the commitment.

Notably, to date the automation of the title insurance commitment process has been limited to document assembly and a template paradigm because federal and state regulations require the manual performance of a title examination. In fact, the entire title insurance industry remains a highly regulated industry in which most state jurisdictions require that title insurance agents register with the state. Most states further require that registered title insurance agents determine the insurability of title in accordance with generally acceptable underwriting rules and standards in reliance on either public records or a search package or both.

The federal government also regulates the title insurance industry as to certain real estate transactions involving federally related mortgage loans by the Department of Housing and Urban Development (HUD). To that end, HUD has issued regulations implementing the Real Estate Settlement Procedures Act (RESPA). Section 8(a) of RESPA prohibits any person from giving or accepting any fee, kickback, or thing of value for the referral of settlement service business involving a federally related mortgage loan. Section 8(b) of RESPA, by comparison, prohibits any person from giving or accepting any portion, split or percentage of any charge made or received for the rendering of a settlement service other than for services actually performed.

Two exemptions to the RESPA Section 8 prohibitions against compensated referrals in RESPA covered transactions involve payments for title insurance services actually performed. Section 8(c)(1)(B) specifically exempts payments of a fee “by a title company to its duly appointed agent for services actually performed in the issuance of a policy of title insurance.” A more general provision, section 8(c)(2), exempts the “payment to any person of a bona fide salary or compensation or other payment for goods or facilities actually furnished or for services actually performed.” In enacting RESPA, Congress stated its intent that section 8 of RESPA did not prohibit payments by title insurance companies for “goods furnished or services actually rendered, so long as the payment bears a reasonable relationship to the value of the goods or services received by the person or company making the payment.”. The legislative report stated that “to the extent the payment is in excess of the reasonable value of the goods provided or services performed, the excess may be considered a kickback or referral fee proscribed by Section [8].”

The legislative history of section 8(c)(1)(B) also noted that the “value of the referral itself is not to be taken into account in determining whether the payment is reasonable.” In particular, Congress specifically elaborated on the exemption for payments made by title insurance companies to duly appointed agents for services actually performed in the issuance of a policy of title insurance and stated:
“Such agents, who in many areas of the country may also be attorneys, typically perform substantial services for and on behalf of a title insurance company. These services may include a title search, an evaluation of the title search to determine the insurability of the title (title examination), the actual issuance of the policy on behalf of the title insurance company, and the maintenance of records relating to the policy and policy-holder. In essence, the agent does all of the work that a branch office of the title insurance company would otherwise have to perform.”

On Nov. 2, 1992, HUD issued regulations that, among other things, gave guidance concerning title agent services under RESPA. These regulations relied in part on the legislative history. Section 3500.14(g)(3) of the regulations provides an example of the type of substantial or “core” title insurance agent services necessary for an attorney to receive multiple fees in a RESPA covered transaction. Specifically, to qualify for a section 8(c)(1)(B) exemption, the attorney title insurance agent must “provide his client with core title agent services for which he assumes liability, and which includes, at a minimum, the evaluation of the title search to determine insurability of the title, and the issuance of a title commitment where customary, the clearance of underwriting objections, and the actual issuance of the policy or policies on behalf of the title company.

Generally, it is beneficial for title insurance companies and their agents to qualify under the section 8(c)(1)(B) exemption since HUD does not normally scrutinize the payments as long as they are “for services actually performed in the issuance of a policy of title insurance.” Thus, to qualify for particular statutory exemptions, RESPA can require a manual title analysis in issuing a title insurance commitment. Yet, it will be recognized that the operation of state and federal regulations, particularly the requirement that a title insurance agent examine the title of a parcel under study, dampen what otherwise would be an ideal forum for computerized automation in the issuance of a title insurance commitment.

### SUMMARY OF THE INVENTION

The present invention addresses the deficiencies of the art in respect to the assembly of title insurance commitments and provides a novel and non-obvious method, system and apparatus for producing a title insurance commitment regardless of the locality of the title insurance examiner and in accordance with specified title examination requirements of RESPA. In accordance with the present invention, an automated system for producing a title insurance commitment can include a database of title evidence images which can be viewed through an image viewer. As required by RESPA in order to qualify for a section 8(c)(1)(b) exemption, a title insurance examiner can produce a title insurance commitment based upon a review of the title insurance evidence presented through the image viewer.

A first set of multi-locality textual clauses can be provided, which clauses can specify minimal requisite language for a title commitment. A second set of multi-locality textual clauses further can be provided, which clauses can specify minimal exclusionary language for a title commitment. The system yet further can include a filter for reducing the first and second sets to locality-specific textual clauses of minimal requisite and exclusionary language. A user interface can be configured to present the locality specific textual clauses in selectable form. Consequently, a title commitment processor can be programmed to generate a title commitment based upon selected ones of the locality specific textual clauses. Finally, once created, the title insurance commitment can be forwarded to a closing system through a corresponding interface to the closing system.

A method of producing a title insurance commitment can include reducing a multi-jurisdictional set of textual clauses for minimum requisite and exclusionary language for a title insurance commitment to a locality specific subset of textual clauses. The locality specific subset can be presented through a user interface in selectable form. At least one electronic image of title evidence can be rendered in the user interface to assist in at least one selection of the locality specific subset of textual clauses. Finally, a title insurance commitment can be produced based upon the selected ones of the locality specific subset of textual clauses.

Importantly, the reducing step can include identifying variable data pertaining to a subject real estate transaction, determining a locality based upon the identified variable data, and reducing a multi-jurisdictional set of textual clauses for minimum requisite and exclusionary language for a title insurance commitment to a locality specific subset of textual clauses based upon the determined locality. Additionally, each of the presenting, rendering and producing steps can be performed over a computer communications network through a markup language document interface. In this regard, a Web interface can be produced through which the document images can be viewed and through which the individual textual clauses of the locality-specific subset can be selected for inclusion in the title insurance commitment.

A title insurance commitment computer program article of manufacture can include a graphical user interface to locality specific textual clauses of minimal requisite and exclusionary language. The locality specific textual clauses can form a subset of a database of multi-locality textual clauses of minimal requisite and exclusionary language. The article of manufacture further can include an image viewer having an activatable link within the graphical user interface for viewing title evidence document images. Finally, the article of manufacture can include at least one user interface widget disposed within the graphical user interface which can specify an output format from among a set of output formats for producing a title insurance commitment formed from a user selection of the locality specific textual clauses presented through the graphical user interface.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:
FIG. 1 is schematic illustration of a title insurance commitment processing system which has been configured in accordance with the inventive arrangements;
FIG. 2 is a flow chart illustrating a process for producing a title insurance commitment in the system of FIG. 1; and,
FIGS. 3A through 3D, taken together, are a pictorial illustration of an exemplary user interface for the title insurance commitment processing system of FIG. 1.

### DETAILED DESCRIPTION OF THE PREFERRED EMBODIMENTS

The present invention is a title insurance commitment processing system, method and apparatus. In accordance with the inventive arrangements, a locality-specific subset of each of multi-state exclusionary and requisite language can be selected from a comprehensive selection of multi-jurisdictional exclusionary and requisite language. The subset can be filtered from the comprehensive selection based upon variables and values specified through a user interface to the system of the invention. A title insurance examination can be performed as required by RESPA through an inspection of one or more images of title evidentiary documents. Subsequently, one or more textual clauses can selected from among the subset for inclusion in a title insurance commitment based upon the examination. Finally, the title insurance commitment can be produced based the selection of textual clauses.

FIG. 1 is schematic illustration of a title insurance commitment processing system which has been configured in accordance with the inventive arrangements. According to a preferred aspect of the present invention, a title insurance commitment processing system can include a set of multi-jurisdictional exclusionary language 120 and a set of multi-state requisite language 130 stored in a fixed storage (not shown). The exclusionary language 120 can include textual clauses for use in producing a title insurance commitment which exclude or limit prospective title insurance coverage for specifically named circumstances. The requisite language 130, by comparison, can include textual clauses for use in producing a title insurance commitment which impose obligations upon the prospective insured party to receive a title insurance coverage for a subject property.

Significantly, the exclusionary language 120 and the requisite language 130 can be generally applicable to any jurisdiction within the United States or any other nation for that matter. Thus, to limit the language which can be applied to a title insurance commitment in any one locality, the exclusionary language 120 and the requisite language 130 can be subjected to a filtering operation 190 based upon variables and values 140 provided through a user interface 110 to the system for producing a title insurance commitment. Specifically, the variables and values 140 can specify a name, location and description for a subject property, the nature of the proposed real estate transaction and information regarding the buyer, the seller and the title insurance examiner.

A commitment production process 200 can be disposed in the system of FIG. 1 and can be coupled to the user interface 110. Through the user interface 1 10, a subset of the exclusionary language 120 and the requisite language 130 can be presented as produced by the filter 190. Specifically, through the user interface 110, individual textual clauses in the subset of the exclusionary language 120 and the requisite language 130 can be presented. Subsequently, the title insurance examiner can select individual ones of the textual clauses as determined to be pertinent by the examiner based upon a substantive examination of the title to the subject parcel.

As it will be understood by the skilled artisan, in order to qualify for the title agent's exemption under section 8(c)(1)(b) of RESPA and to satisfy the requirements of various state laws, the title insurance examiner must perform a substantive examination of subject parcel prior to issuing a title insurance commitment. To that end, the user interface 110 can be coupled via the commitment production process 190 to an on-line title evidence plant 160 which can include one or more title document images 150 which can be examined by the title insurance examiner prior to producing a title insurance commitment. Such document images 150 can include images of real estate and tangible property tax search reports, images of property deeds, images of recorded mortgages, images of liens and lien waivers and the like.

Based upon the selection of individual textual clauses in the user interface 110, the commitment production process 190 can produce a proof of a title insurance commitment 170. The proof of the title insurance commitment 170 can be presented to the title insurance examiner through the user interface 110. Once approved, the title insurance commitment 170 can be forwarded in electronically adaptable form to a closing system 180A, the title insurance commitment 170 can be saved to persistent storage 180B, the title insurance commitment 170 can be printed to hard copy 180C, or the title insurance commitment 170 can be forwarded electronically to a network recipient 180D.

FIG. 2 is a flow chart illustrating a process for producing a title insurance commitment in the system of FIG. 1. Beginning in block 200, the title insurance commitment application can be launched. In block 210, variables and data relating to the underlying real estate transaction can be provided. Subsequently, in block 220 the pertinent locality for the transaction can be identified. In decision block 230, it can be determined whether or not images of title evidence ought to be displayed to assist in the production of a title insurance commitment. If so, in block 240 the images pertaining to the real estate transaction can be displayed.

In blocks 250A and 250B, a subset of each set of textual clauses for the minimum requisite language and the minimum exclusionary language can be selected for display through a user interface of the application. Specifically, the subset can include those textual clauses which are pertinent to the identified locality. In block 260, a selection of textual clauses in the subset of minimum requisite language can be presented in the user interface, which textual clauses can be individually selected for inclusion in a commitment data file or as a lettered subparagraph in the commitment. Likewise, in block 270, a selection of textual clauses in the subset of minimum exclusionary language can be presented in the user interface, which textual clauses can be individually selected for inclusion in a commitment data file.

Finally, in block 280 a proof of the title insurance commitment can be assembled based upon the selections of blocks 260 and 270, and where approved by the title insurance examiner, in block 290 the title insurance commitment can be generated. Importantly, several distinguishing aspects of the process of FIG. 2 will be recognized by one skilled in the art. First and foremost, the textual clauses which can be selected in blocks 260 and 270 are mere locality-specific subsets of a larger selection of textual clauses for multi-jurisdictional application. More importantly, to produce the title insurance commitment in block 290, a title insurance examiner must affirmatively select among the subset of clauses forcing a RESPA compliant examination.

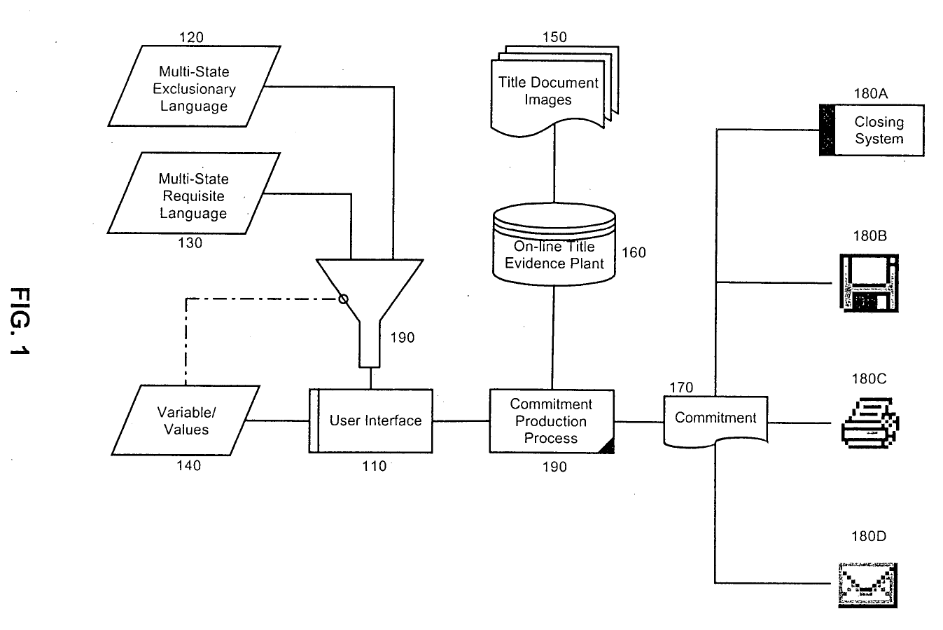

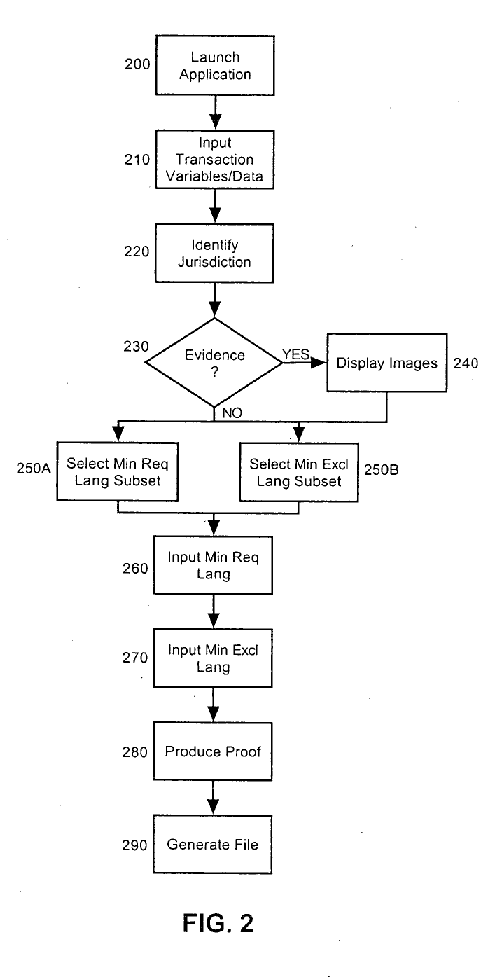

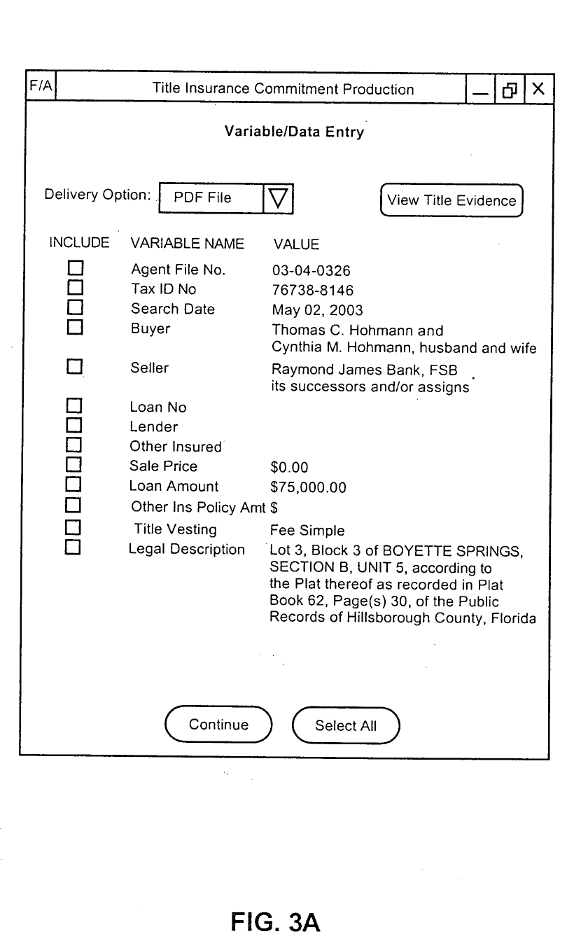

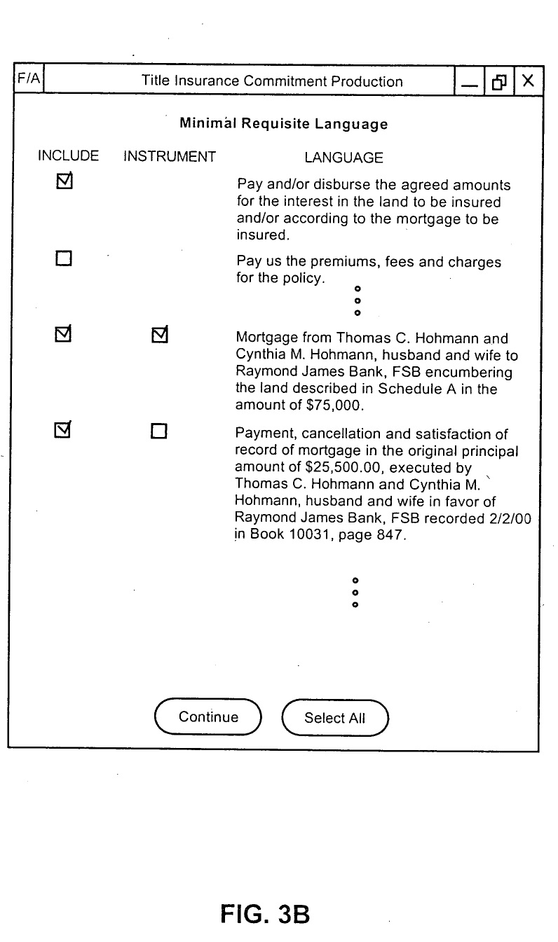

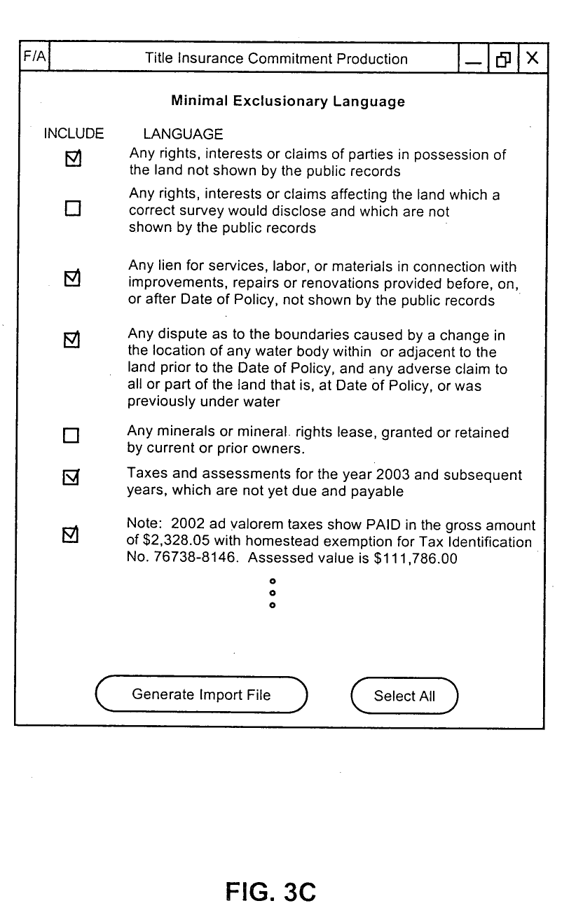

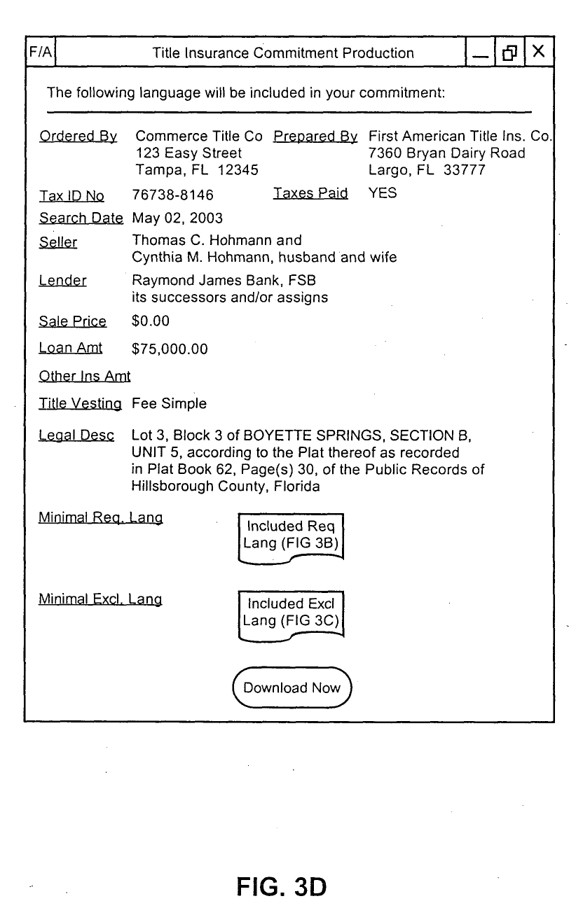

FIGS. 3A through 3D, taken together, are a pictorial illustration of an exemplary user interface for the title insurance commitment processing system of FIG. 1. Beginning with FIG. 3A, a graphical user interface is shown in which variables and data relating to a real estate transaction can be established. The variables and data can include information pertaining to the subject property, the seller and the prospective buyer. Additionally, through the graphical user interface, images of title evidence can be viewed. Notably, the information provided through the display of FIG. 3A can be selectably included in the commitment as decided by the affirmative selection of the title insurance examiner.

FIG. 3B depicts a screen through which individual textual clauses in a state-specific subset of minimal requisite language can be selected for inclusion in a title insurance commitment. As it will be understood from FIG. 3B, individual textual clauses can be selected either or both for inclusion in the underlying commitment or as a lettered subparagraph of the commitment. FIG. 3C, by comparison, depicts a screen through which individual textual clauses in a locality-specific subset of minimal exclusionary language can be selected for inclusion in a title insurance commitment. Finally, FIG. 3D depicts a screen in which a proof of the title insurance commitment can be presented for review by the title insurance examiner. Notably, the selected minimum requisite and exclusionary language clauses of FIGS. 3B and 3C can be included within the proof.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. An automated system for producing a title insurance commitment comprising:
a database of title evidence images;
a first set of multi-locality textual clauses specifying minimal requisite language for a title commitment and a second set of multi-locality textual clauses specifying minimal exclusionary language for a title commitment;
a filter for reducing said first and second sets to locality-specific textual clauses of minimal requisite and exclusionary language;
a user interface configured to present said locality specific textual clauses in selectable form; and,
a title commitment processor programmed to generate a title commitment based upon selected ones of said locality specific textual clauses.

2. The system of claim 1, further comprising an interface to a closing system.

3. A method of producing a title insurance commitment, the method comprising the steps of:
reducing a multi-jurisdictional set of textual clauses for minimum requisite and exclusionary language for a title insurance commitment to a locality specific subset of textual clauses;
presenting said locality specific subset in selectable form;
rendering at least one electronic image of title evidence to assist in at least one selection of said locality specific subset of textual clauses; and,
producing a title insurance commitment based upon said selected ones of said locality specific subset of textual clauses.

4. The method of claim 3, further comprising the step of performing said presenting, rendering and producing step over a computer communications network through a markup language document interface.

5. The method of claim 3, wherein said reducing step comprises the steps of:
identifying variable data pertaining to a subject real estate transaction;
determining a locality based upon said identified variable data; and,
reducing a multi-jurisdictional set of textual clauses for minimum requisite and exclusionary language for a title insurance commitment to a locality specific subset of textual clauses based upon said determined locality.

6. A machine readable storage having stored thereon a computer program for producing a title insurance commitment, the computer program comprising a routine set of instructions for causing the machine to perform the steps of:
reducing a multi-jurisdictional set of textual clauses for minimum requisite and exclusionary language for a title insurance commitment to a locality specific subset of textual clauses;
presenting said locality specific subset in selectable form;
rendering at least one electronic image of title evidence to assist in at least one selection of said locality specific subset of textual clauses; and,
producing a title insurance commitment based upon said selected ones of said locality specific subset of textual clauses.

7. The machine readable storage of claim 6, further comprising the step of performing said presenting, rendering and producing step over a computer communications network through a markup language document interface.

8. The machine readable storage of claim 6, wherein said reducing step comprises the steps of:
identifying variable data pertaining to a subject real estate transaction;
determining a locality based upon said identified variable data; and,
reducing a multi-jurisdictional set of textual clauses for minimum requisite and exclusionary language for a title insurance commitment to a locality specific subset of textual clauses based upon said determined locality.

9. A title insurance commitment computer program article of manufacture comprising:
a graphical user interface to locality specific textual clauses of minimal requisite and exclusionary language, said locality specific textual clauses forming a subset of a database of multi-locality textual clauses of minimal requisite and exclusionary language;
an image viewer having an activatable link within said graphical user interface for viewing title evidence document images; and,
at least one user interface widget disposed within said graphical user interface which can specify an output format from among a set of output formats for producing a title insurance commitment formed from a user selection of said locality specific textual clauses presented through said graphical user interface.
